(19) United States
(12) Patent Application Publication
(10) Pub. No.: US 2017/0236630 A1
(43) Pub. Date: Aug. 17, 2017

(54) Magnetically Latching Flux-Shifting Electromechanical Actuator

(71) Applicant: Eaton Corporation, Cleveland, OH (US)

(72) Inventors: Amogh Vilas Kank, Thane (IN); Mark Allan Juds, New Berlin, WI (US); Mustafa Huseyin, London (GB); Peter John Theisen, West Bend, WI (US)

(73) Assignee: Eaton Corporation, Cleveland, OH (US)

(21) Appl. No.: 15/502,900

(22) PCT Filed: Jul. 31, 2015
(86) PCT No.: PCT/US15/43069

§ 371 Date: Feb. 9, 2017

Related U.S. Application Data
(60) Provisional application No. 62/190,460, filed on Jul. 9, 2015.

(30) Foreign Application Priority Data
Aug. 18, 2014 (IN) 2335/DEL/2014

(51) Int. Cl. H01F 7/18; H01F 7/16; H01F 7/08

(52) U.S. Cl. CPC H01F 7/1805; H01F 7/081; H01F 7/1646; H01F 2007/086

(57) ABSTRACT

A latching electromechanical actuator (9) includes a soft iron armature (31) movable between first and second positions, a permanent magnet (5A), a solenoid (23), and a soft iron external frame (11). The permanent magnet (5A) may be stationary relative to the solenoid (23) and operative to hold the armature (31) stably in either the first position or the second position. The actuator (9) provides two distinct magnetic flux paths (24A, 24B), one or the other of which is the primary flux path for the permanent magnet (5A) depending on whether the position of armature (31). Both flux paths pass through the armature (31). One of the flux paths may pass through the external frame (11). The other does not. The actuator (9) may include two permanent magnets (5) performing complementary roles for the first and second positions. The actuator (9) can be simply constructed, compact, and highly efficient.

### PRIORITY

This application claims the benefit of India Provisional Application No. 2335/DEL/2014, filed Aug. 18, 2014 and U.S. Provisional Application No. 62/190460, filed Jul. 9, 2015.

### FIELD

The present disclosure relates generally to actuators and more particularly to magnetically latching solenoids.

### BACKGROUND

Electromechanical actuators convert electric current into mechanical motion. An electromechanical actuator can include a solenoid wound about a movable ferromagnetic armature. When current is passed through the solenoid, a magnetic flux is generated. In a typical design, the actuator is designed to include an air gap that can be reduced by moving the armature. The air gap lies in a path taken by magnetic flux from the solenoid. When the solenoid is energized, it magnetizes the armature and draws it in a direction that reduces the air gap. A spring can be configured to move the armature in the direction that increases the air gap. The spring determines the position of the armature when the solenoid's power is off.

A latching electromechanical actuator differs from this typical design in that the armature remains in place when the solenoid's power is disconnected. This can be accomplished, for example, by placing a permanent magnet where it holds the armature against the spring force when the armature is in the reduced air gap position. The armature may be displaced from the latched position by providing the solenoid with a short pulse of current having suitable polarity.

### SUMMARY

According to some aspects of the present teachings, a latching electromechanical actuator includes an armature movable between first and second positions, a permanent magnet, a solenoid, and an external frame for the solenoid having one or more sections formed of low coercivity ferromagnetic material. At least a portion of the armature is also composed of low coercivity ferromagnetic material. The permanent magnet may be stationary relative to the solenoid and operative to hold the armature stably in either the first position or the second position. Absent magnetic fields from the solenoid or any external source, the actuator provides two distinct magnetic flux paths, one or the other of which is the primary flux path for the permanent magnet depending on whether the armature is in the first or the second position. Both flux paths pass through the armature. One of the flux paths may pass around the solenoid's coils through the external frame. The other does not.

In operation, a voltage of a first polarity may be applied to the solenoid to actuate the armature from the first to the second position. The magnetic field generated by the solenoid may alter magnetization within the armature and the external frame in a way that increases magnetic reluctance in the first flux path. The magnetic flux from the permanent magnet may consequently shift toward the second flux path as the armature experiences forces the net result of which cause it to travel from the first position to the second position. The armature may then be held stable in the second position even if the solenoid is disconnected from the voltage source.

A voltage having a reverse of the first polarity may subsequently be applied to the solenoid to increase the magnetic reluctance in the second flux path. The magnetic flux from the permanent magnet may consequently shift toward the first flux path as the armature experiences forces the net result of which cause it to travel from the second position back to the first position. The armature may then be held stable in the first position even if the solenoid is disconnected from the voltage source.

By using a solenoid to destabilize one or the other of two magnetic flux paths, one that stabilizes the actuator in a first position and another that stabilizes the actuator in a second position, an electromechanical actuator according to these teaching may be operative with greater efficiency as compared to an electromechanical actuator that operates by overwhelming the holding force of a permanent magnet. The greater efficiency may allow the use of a smaller solenoid. Making the permanent magnet stationary relative to the solenoid allows it to be mounted off the armature, whereby the magnet does not contribute to the inertia of the armature. Structuring the actuator so that the primary magnetic flux path for the permanent magnet passes through the armature without going around the external frame reduces magnetic flux leakage and increases the holding force per unit mass provided by the permanent magnet when the armature is in the second position.

In some of these teachings, a pole piece for the permanent magnet is positioned within the solenoid. The pole piece may abut a pole of the permanent magnet. The pole piece may be positioned to facilitate passage of magnetic flux from the permanent magnet to the armature. In some of these teachings, the permanent magnet has the form of an annular ring. The magnet may be polarized in a direction parallel to an axis of the solenoid. In some of these teachings, the pole piece is an annular ring of low coercivity ferromagnetic material positioned within the solenoid adjacent the permanent magnet. The ring's position may be fixed with respect to the permanent magnet. These forms simplify construction of the actuator.

In some of these teachings, the armature has a stepped edge formed of low coercivity ferromagnetic material. When the armature is in the first position, the stepped edge of the armature may mate with correspondingly shaped low coercivity ferromagnetic material abutting or forming part of the external frame. The edge of the armature may be operative as a pole face and the stepped edge may increase the force with which the solenoid can move the armature from the second position to the first.

In some aspects of the present teachings, the actuator includes two permanent magnets. The actuator may form distinct magnetic flux paths for each of the permanent magnets in each of two stable armature positions. Different paths may be primary for each of the permanent magnets depending on the position of the armature. In some of these teaching, in each of two stable armature positions, one of the permanent magnets has a primary magnetic flux path that passes through the armature without going around the external frame. With these features, in both the first and second positions, the armature is well stabilized by the permanent magnets and the solenoid can actuate the armature by a flux path shifting mechanism that applies simultaneously to the fields of both permanent magnets. In some of these teachings, the two permanent magnets are arranged with confronting polarity. In some of these teachings, both magnets are radially adjacent the armature. These design feature facilitate making the actuator compact and efficient.

In some of these teachings, a primary path for magnetic flux produced by the solenoid when energized has a first air gap when the armature is in the first position and a second air gap when the armature is in the second position. As the armature translates between the first and second positions, the one of the air gaps increases in size while the other decreases. The net result is that the total air gap in the solenoid's magnetic circuit does not vary substantially with armature movement and movement of the armature is driven primarily by the permanent magnets through a flux shifting mechanism.

In some aspects of the present teachings, the actuator includes a spring biasing the actuator from the second position to the first position. The spring may be configured whereby the spring's force on the armature when the armature is in the first position is one fourth or less the spring's force on the armature when the armature is in the second position. In some of these teachings, the spring becomes fully extended before the actuator reaches the first position. The spring may increase the force on the armature during translation and increase the speed with which the armature can be actuated from the second position to the first. In some others of these teachings, a second spring is likewise configured to bias the armature from first position to the second.

According to some aspects of the present teachings, a latching electromechanical actuator includes an annular structure including two annular permanent magnets magnetized in the directions of their axes and arranged in confronting polarity with an annular ring of low coercivity ferromagnetic material between them and abutting each of them. A solenoid has coils encircling the annular structure. A shell of low coercivity ferromagnetic material surrounds the radially outward portion of the solenoid. Additional pieces of low coercivity ferromagnetic material covers the ends of the solenoid and extend from the annular structure to the external frame. An armature is mounted in a configuration where a portion of the armature comprising low coercivity ferromagnetic material remains within the annular structure. The actuator is compact, efficient, and latching.

Some aspects of the present teachings provide methods of operating an electromechanical actuator having a solenoid and an armature. In some of these teachings, an armature may be held in a first position using a first permanent magnet that generates a magnetic field following a first flux path that encircles the solenoid's coils. The solenoid may subsequently be connected to a DC voltage source having a first polarity, whereby it generates a magnetic field that redirects the magnetic flux from the first permanent magnet and causes the armature to be displaced from the first position to a second position. The solenoid may be disconnected from the DC voltage source after the solenoid's action is no longer needed to complete the movement of the armature from the first position to the second position. The armature may then be held in the second position using the first permanent magnet. In the second position, the first permanent magnet generates a magnetic field that follows a second flux path, which does not encircle the solenoid's coils. The solenoid may subsequently be connected to a DC voltage source having a second polarity, which is a reverse of the first polarity, to generate a magnetic field that redirects the magnetic flux from the first permanent magnet and causes the armature to be displaced from the second position to the first position. A DC voltage source can be, for example, a generator, a charged capacitor, or a charged battery.

In some of these teachings, the holding of the armature in the first position using the first permanent magnet further includes holding the armature in the first position using a second permanent magnet that generates a magnetic field following a third flux path that does not encircle the solenoid's coils. Likewise, in some of these teachings the holding of the armature in the second position using the first permanent magnet further includes holding the armature in the second position using a second permanent magnet that generates a magnetic field following a fourth flux path that encircles the solenoid's coils.

The primary purpose of this summary has been to present certain of the inventors' concepts in a simplified form to facilitate understanding of the more detailed description that follows. This summary is not a comprehensive description of every one of the inventors' concepts or every combination of the inventors' concepts that can be considered “invention”. Other concepts of the inventors will be conveyed to one of ordinary skill in the art by the following detailed description together with the drawings. The specifics disclosed herein may be generalized, narrowed, and combined in various ways with the ultimate statement of what the inventors claim as their invention being reserved for the claims that follow.

### BRIEF DESCRIPTION OF THE DRAWINGS

FIG. 1 illustrates a half cross-section of an electromechanical actuator in accordance with some aspects of the present teachings with the armature in a first position.

FIG. 2 illustrates a magnetic field that can be generated by a solenoid of the actuator of FIG. 1.

FIG. 3 illustrates the actuator of FIG. 1 with the armature in a second position.

FIG. 4 illustrates a half cross-section of an electromechanical actuator in accordance with some other aspects of the present teachings with the armature in a first position.

FIG. 5 illustrates the actuator of FIG. 4 with the armature in motion.

FIG. 6 illustrates the actuator of FIG. 4 with the armature in a second position.

FIG. 7 illustrates force versus armature position relationships that may be expected for the actuator of FIGS. 4-6.

FIG. 8 illustrates force versus armature position relationships that may be expected for the actuator of FIG. 9.

FIG. 9 illustrates a half cross-section of an electromechanical actuator in accordance with some other aspects of the present teachings.

FIG. 10 illustrates a half cross-section of an electromechanical actuator in accordance with some other aspects of the present teachings.

FIG. 11 illustrates a half cross-section of an electromechanical actuator in accordance with some other aspects of the present teachings.

FIG. 12 illustrates a half cross-section of an electromechanical actuator in accordance with some other aspects of the present teachings.

FIG. 13 illustrates force versus armature position relationships that may be expected for the actuator of FIG. 11.

FIG. 14 provides a flow chart of a method in accordance with some aspects of the present teachings.

### DETAILED DESCRIPTION

In the drawings, some reference characters consist of a number followed by a letter. In this description and the claims that follow, a reference character consisting of that same number without a letter is equivalent to a listing of all reference characters used in the drawings and consisting of that same number followed by a letter. For example, “electromechanical actuator 109” is the same as “electromechanical actuator 109A, 109B, 109C, 109D, 109E”.

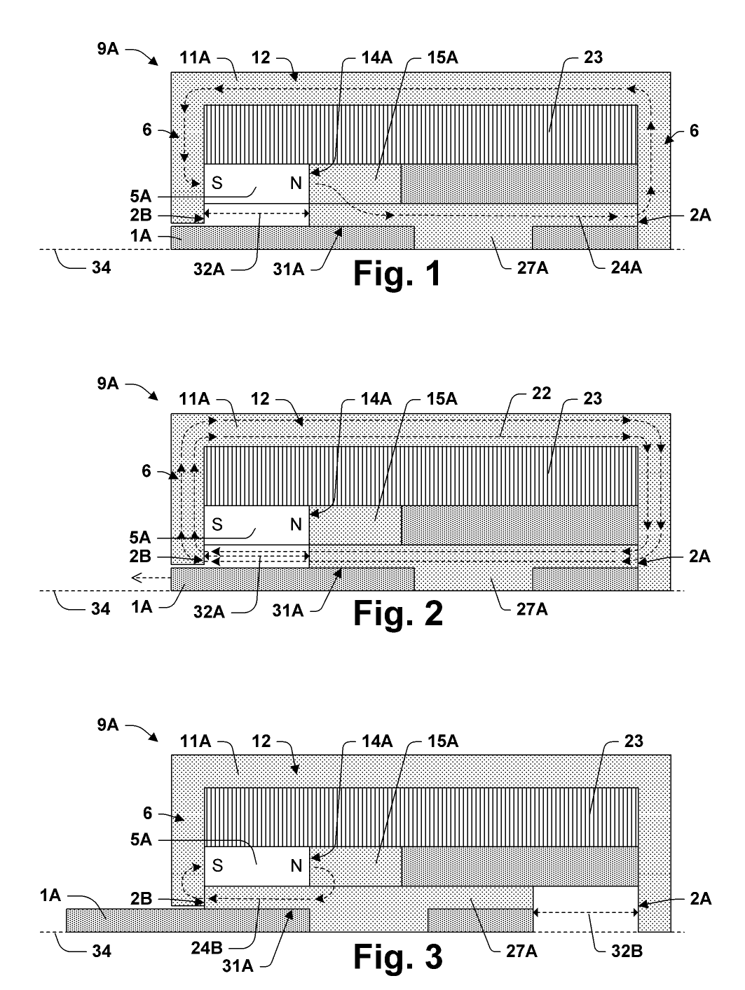

FIGS. 1-3 illustrate an electromechanical actuator 109A providing an example in accordance with some aspects of the present teachings. Actuator 109A may be symmetric about an axis 34. FIGS. 1-3 shows a cross-section through and to one side of axis 34. Actuator 109A includes a solenoid 23, an armature 31A, an external frame 11A, and at least one permanent magnet 5A. Solenoid 23 includes a plurality of coils (not shown individually), which circle about axis 34. Armature 31A is translatable along axis 34 between a first position and a second position, includes a low coercivity ferromagnetic portion 27A, and may include additional parts 1A. FIGS. 1 and 2 show armature 31A in the first position and FIG. 3 shows armature 31A in the second position. At least a part of low coercivity ferromagnetic portion 27A of armature 31A may be encircled by coils of solenoid 23 and is therefore within solenoid 23.

Permanent magnet 5A may be within solenoid 23. In some aspects of the present teach, permanent magnet 5A is entirely within solenoid 23. According to some aspects of the present teaching, permanent magnet 5A is stationary with respect to solenoid 23. In some of these teachings, permanent magnet 5A is radially outward from armature 31A, whereby permanent magnet 5A may be said to be between armature 31A and solenoid 23. In some of these teachings, permanent magnet 5A is adjacent armature 31A. In some of these teachings, permanent magnet 5A is polarized along a direction parallel to axis 34. Permanent magnet 5A may be annular in structure and surround armature 31A. As used herein, a permanent magnet is a high coercivity ferromagnetic material with residual magnetism. A high coercivity means that the polarity of permanent magnet 5A remains unchanged through hundreds of operations through which solenoid 23 is operated to switch armature 31A between the first and second positions. Examples of high coercivity ferromagnetic materials include compositions of AlNiCo and NdFeB. Soft iron is an example of a low coercivity ferromagnetic material.

External frame 11A may be formed of one or more sections of low coercivity ferromagnetic material including a portion 12 on the outside side of solenoid 23 and portions 6 over the ends of solenoid 23. In some of these teachings, external frame 11A forms a shell around solenoid 23. In some of these teachings, low coercivity ferromagnetic portion 27A of armature 31A abuts external frame 11A at a first location 2A when armature 31A is in the first position and at a second location 2B when armature 31A is in the second position. External frame 11A may provide a continuous path of low coercivity ferromagnetic between locations 2A and 2B.

In some aspects of the present teachings, solenoid 23 may be formed of a single winding of coils in one direction about axis 34. This provides the simplest and most compact construction. Alternatively, solenoid 23 may be provided by a plurality of windings. In some of these teachings, solenoid 23 includes two windings, each wound in a different direction. This allows the use of simpler circuitry for reversing the polarity of the magnetic field produced by solenoid 23.

In some of these teachings, a pole piece 15A is positioned adjacent low coercivity ferromagnetic portion 27A of armature 31A and in abutment to pole 14A of permanent magnet 5A. In some of these teachings, pole piece 15A facilitates the passage of magnetic flux from pole 14A to low coercivity ferromagnetic portion 27A of armature 31A. In some of these teachings, pole piece 15A has the form of an annular ring.

As shown in FIG. 1, when armature 31A is in the first position, actuator 9A may form a first magnetic flux path 24A that passes through ferromagnetic portion 27A of armature 31A and around the coils of solenoid 23 via external frame 11A. Pole piece 15A may also form part of magnetic flux path 24A. In some aspects of these teachings, magnetic flux path 24A is the primary magnetic flux path for permanent magnet 5A when armature 31A is in the first position and no external magnetic fields or fields from solenoid 23 are altering the path of that flux. As the term is used herein, a primary magnetic flux path for a permanent magnet is a path taken by at least half the flux between that magnets' poles. Magnetic flux may follow a particular path due to the low reluctance of that path in comparison to other paths. Displacing armature 31A from the first position creates an air gap in magnetic flux path 24A, which increases the magnetic reluctance of that path. The magnetic field from permanent magnet 5A resists such changes and therefore stabilizes armature 31A in the first position.

As shown in FIG. 3, when armature 31A is in the second position, actuator 9A may form a second magnetic flux path 24B that passes through ferromagnetic portion 27A of armature 31A but unlike path 24A, does not pass around the coils of solenoid 23. Pole piece 15A may also form part of magnetic flux path 24B. In some aspects of these teachings, magnetic flux path 24A is the primary magnetic flux path for permanent magnet 5A when armature 31A is in the second position and no external magnetic fields or fields from solenoid 23 are altering the path of that flux. Displacing armature 31A from the second position creates an air gap in magnetic flux path 24B, which increases the magnetic reluctance of that path. The magnetic field from permanent magnet 5A resists such changes and therefore stabilize armature 31A in the second position.

FIG. 2 shows a flux path 22 for magnetic flux that may be produced by solenoid 23. As shown in FIG. 2, when armature 31A is in the first position, magnetic flux from solenoid 23 crosses an air gap 32A. As shown in FIG. 3, moving armature 31 from the first position to the second position close air gap 32A and opens another air gap 32B. In some of these teachings, the sum length of these two air gaps remains constant as armature 31A moves.

A low reluctance flux path may be formed in a low coercivity ferromagnetic material when that material is magnetized by that flux. As shown in FIGS. 1 and 2, while armature 31A is in the first position, solenoid 23 may be energized to create a magnetic field 22 that changes the induced polarity in the low coercivity ferromagnetic materials in the flux path 24A, which greatly increases the reluctance of that path for flux from permanent magnet 5A. Under the influence of magnetic field 22, the primary magnetic flux path for permanent magnet 5A may shift away from flux path 24A toward flux path 24B. Armature 31A may become unstable in the first position and experience net forces that drive it toward the second position. Under the influence of these forces, armature 31A may migrate toward the second position where it may again be stable even after solenoid 23 is de-energized and magnetic field 22 has dissipated.

Solenoid 23 may subsequently be energized with a current in the reverse direction, which is the opposite of the first direction, whereby magnetic field 22 is again created but with a reverse polarity. This may increase the reluctance of flux path 24B, cause armature 31A to migrate back to the first position, and reestablish flux path 24A as the primary flux path for permanent magnet 5A.

Energizing solenoid 23 may be connecting a circuit (not shown) comprising solenoid 23 to a DC voltage source (not shown). In some of these teachings, to reverse the direction of the current, the circuit is again connected to the voltage source, but with a reverse polarity. This may be accomplished with, for example, an H-bridge. Alternatively, different voltage sources may be connecting depending on whether a forward or reverse current is desired in solenoid 23. In some others of these teachings, solenoid 23 may include a first set of coils provided to increase the reluctance of flux path 24A and a second set of coils provided to increase the reluctance of flux path 24B. The two sets of coils may be electrically isolated and wound in different directions.

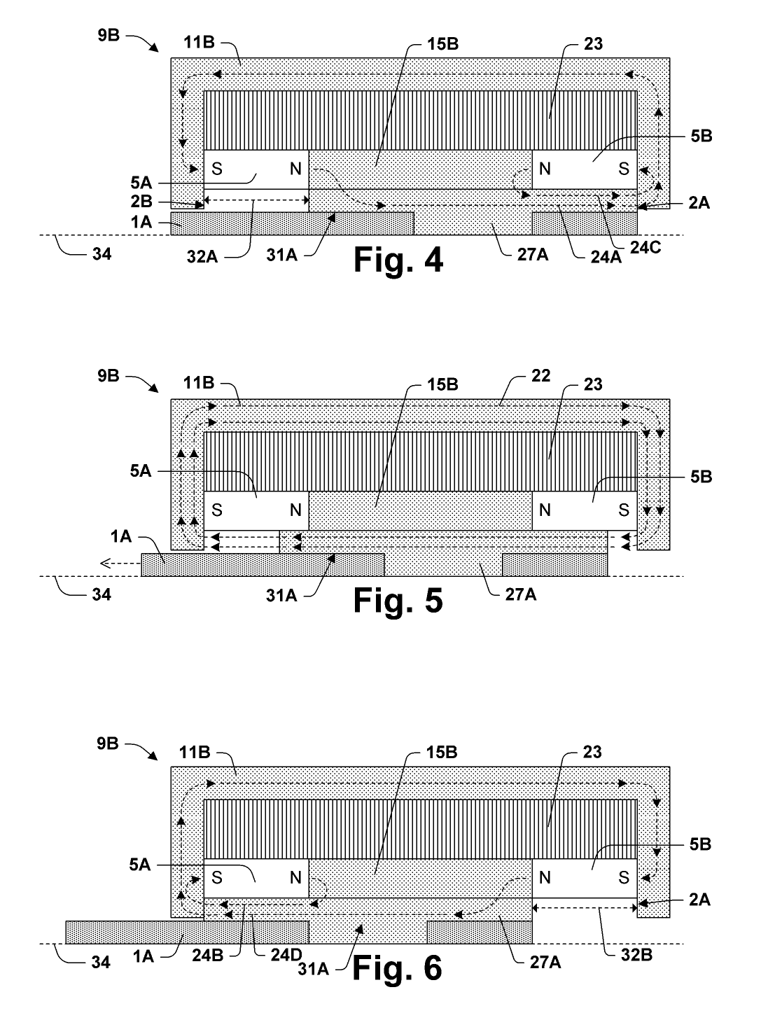

According to some aspects of the present teachings, the performance of electromagnetic actuator 9A may be improved by adding a second permanent magnet 5B that plays a complementary role to permanent magnet 5A. Electromagnetic actuator 9B illustrated by FIGS. 4-6 provides an example. In some of these teachings, permanent magnet 5B is positioned within solenoid 23. In some of these teachings, permanents magnets 5A and 5B are proximate opposite ends of solenoid 23. In some of these teachings, permanent magnet 5B is arranged with its polarity confronting that of permanent magnet 5A. In some of these teachings, a pole piece 15B is positioned between the facing poles of permanent magnets 5A and 5B. In some of these teachings, pole piece 15B is in the form of an annular ring.

A complementary role means having a primary magnetic flux path meeting the description of flux path 24B when armature 31A is in the first position and a primary magnetic flux path meeting the description of flux path 24A when armature 31A is in the second position. For example, as shown in FIG. 4, the primary path for magnetic flux from permanent magnet 5B when armature 31A is in the first position is flux path 24C. Flux path 24C is similar to flux path 24B, which is shown in FIGS. 3 and 6 and is the primary path for magnetic flux from permanent magnet 5A when armature 31A is in the second position. Flux path 24C passes through ferromagnetic portion 27A of armature 31A without passing around the coils of solenoid 23. Flux paths 24C and 24B may be comparatively short and the magnetic flux taking these paths may provide a relatively strong holding forces for armature 31A in the first and second positions respectively. Both permanent magnet 5A and permanent magnet 5B may contribute to stabilizing the position of armature 31A in both the first and second positions.

FIG. 5 illustrates how solenoid 23 can simultaneously redirect the flux from permanent magnets 5A and 5B from paths 24A and 24C respectively and cause armature 31A to move to the second position. FIG. 6 illustrates magnetic flux paths 24B and 24D, which become the new primary flux paths for permanent magnets 5A and 5B when armature 31A reaches the second position.

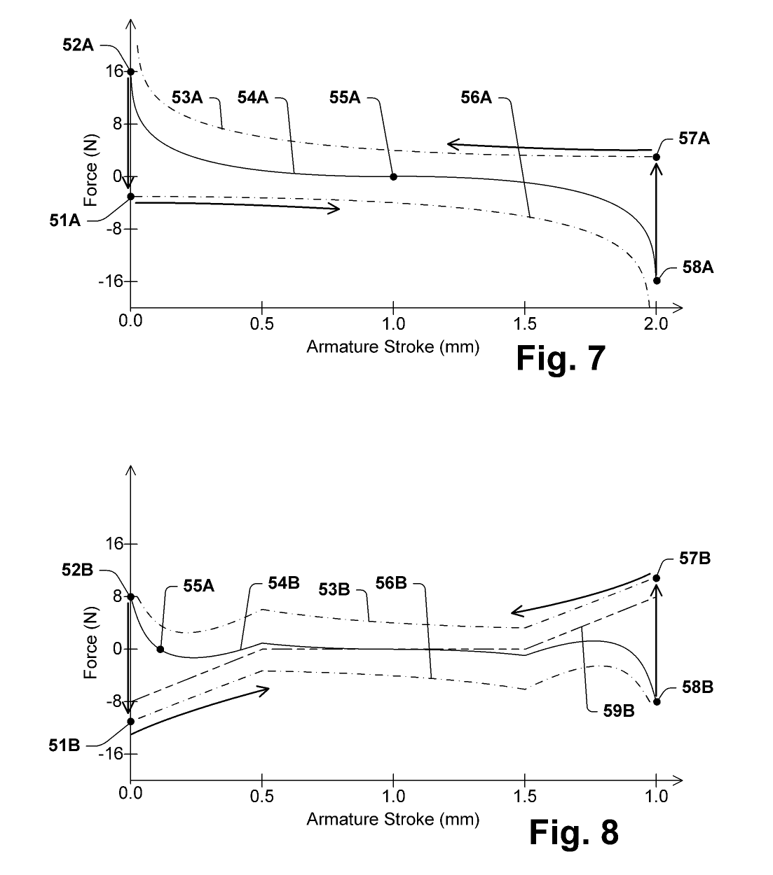

FIG. 7 illustrates how the forces on armature 31A in actuator 9B may vary with translation of armature 31A along axis 34. Curve 54A shows the net magnetic force on armature 31A along axis 34 when solenoid 23 is without power. Point 52A corresponds to the first position and point 58A corresponds to the second position. If armature 31A is anywhere past the midpoint 55A, armature 31A will be drawn to whichever of the first and second positions it is closest to. Accordingly, when solenoid 23 is being operated to actuate armature 31A, it may be disconnected from its energy source as soon as armature 31A has reached midpoint 55A.

Curve 56A illustrates the forces on armature 31A when solenoid 23 is energized with current in the forward direction. The arrow from point 52A to point 51A illustrates the effect when the power source is connected. Curve 56A illustrates that when solenoid 23 is energized with a current in the forwards direction, armature 31A may be pulled toward the second position regardless of where armature 31A currently is in its range of travel. Likewise, the arrow from point 58A to 57A illustrates the effect when solenoid 23 is energized with current in the reverse direction while armature 31A is in the second position. The force versus position curve become curve 53A and armature 31A may be drawn back to the first position.

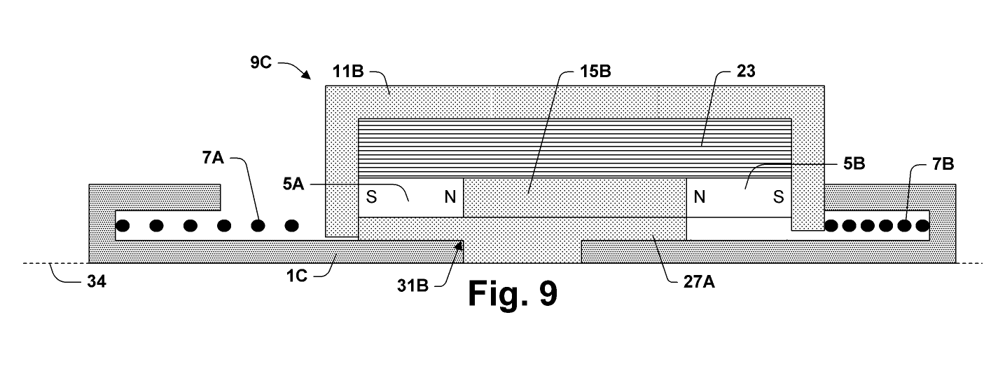

In some aspects of the present teachings, one or more springs are used to alter these force versus position curves. The variation may be for the purpose of increasing the switching speed of actuator 9. FIG. 9 illustrates an electromechanical actuator 9C providing an example according to these teachings. Actuator 9C includes spring 7A, which is configured to bias armature 31B from the first position toward the second and a spring 7B, which is configured to bias armature 31B from the second position toward the first.

In some aspects of the present teachings, an actuator 9 includes only one of the springs 7. In some of these teachings, an armature 31 is held more strongly in either the first or the second position by one or more permanent magnets 5. If a single spring 7 is used, it may be positioned to bias the armature 31 out of the position in which permanent magnets 5 hold armature 31 more strongly. That position may be one in which a permanent magnet 5 assumes a short primary flux path that passes through armature 31 without encircling the coils of solenoid 23.

FIG. 8 illustrates how the force versus position curves may be changed by springs 7. Curve 59B illustrates the forces provided by springs 7A and 7B. Curve 54B shows the net forces on armature 31B from permanent magnets 5A and 5B and springs 7A and 7B. Comparison with FIG. 7 shows the effect of these springs may be to reduce the force with which armature 31B is held in the first or second position and to increase the force with which armature 31B is actuated through operation of solenoid 23. This effect may increase the speed with which armature 31B can be actuated between the first and second positions.

As shown by curve 59B, springs 7A and 7B may be configured in such a way that the forces they apply to armature 31B rapidly diminish from their maximal values, which occur when armature 31B is in the first or second position. For example, spring 7A is configured to provide a biasing force that tends to move armature 31B from the first position toward the second position. This force is at a maximum when armature 31B is in the first position, decreases approximately linearly as armature 31B move towards the second position, and reaches zero corresponding to full extension of spring 7A when armature 31B has travelled one quarter of the way toward the second position. This kind of behavior reflects a design having the objective of increasing the actuation speed toward the second position as opposed to holding armature 31B in the second position. In some of these teachings, a spring 7's force at one of armature 31's first and second positions is one fourth or less the spring 7's force at the other of the armature 31's first and second positions. In some of these teachings, a spring 7 fully extends before armature 31 reaches the first or second position.

According to some aspects of the present teachings, the force versus armature position characteristics of an electromechanical actuator 9 are modified by suitably shaping end faces of low coercivity ferromagnetic portion 27 of armature 31 and mating ferromagnetic elements in actuator 9. FIG. 10-12 provide examples according to these teachings. In some of these teachings, the end faces are tapered. FIG. 10 illustrates an electromechanical actuator 9D providing an example according to these teachings. Tapered faces 37A on low coercivity ferromagnetic portion 27D of armature 31D mate with tapered faces 35A of pole pieces 7D that abuts external frame 11B. In this and other examples according to the present teachings, surfaces 35 that mate with end faces 37 of low coercivity ferromagnetic portion 27 may be provided by pole pieces 7 and/or external frame 11. Tapered faces 37A reduce the holding force provided by magnets 5 while increasing the force at the open gap and the speed with which armature 31D can be actuated.

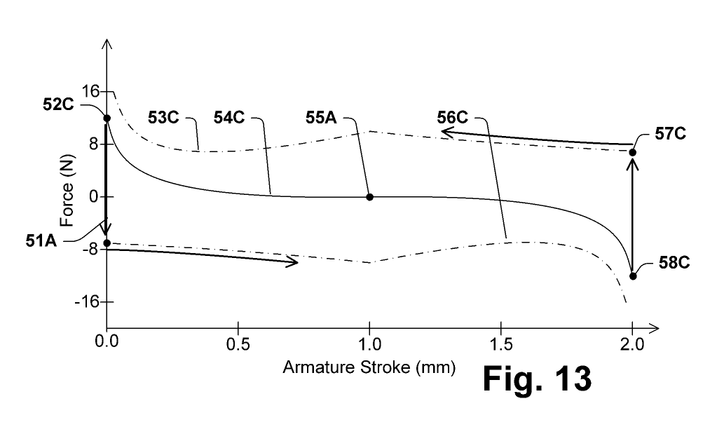

In some of these teachings, low coercivity ferromagnetic portion 27 of armature 31 has a stepped edge. FIG. 11 illustrates an electromechanical actuator 9E providing an example according to these teachings. Stepped edges 37B on low coercivity ferromagnetic portion 27E of armature 31E mate with tapered faces 35B provided by pole piece 7E and external frame 11B. FIG. 13 illustrates how the magnetic forces on armature 31E may vary with translation of armature 31E along axis 34. As shown by comparison between curve 54C of FIG. 13 and curve 54A of FIG. 7, stepped edges 37B reduce the holding force provided by magnets 5 while increasing the force at the open gap and the speed with which armature 31E can be actuated. Stepped edges 37B also provide a reduced air gap 32C for solenoid 23's magnetic circuit.

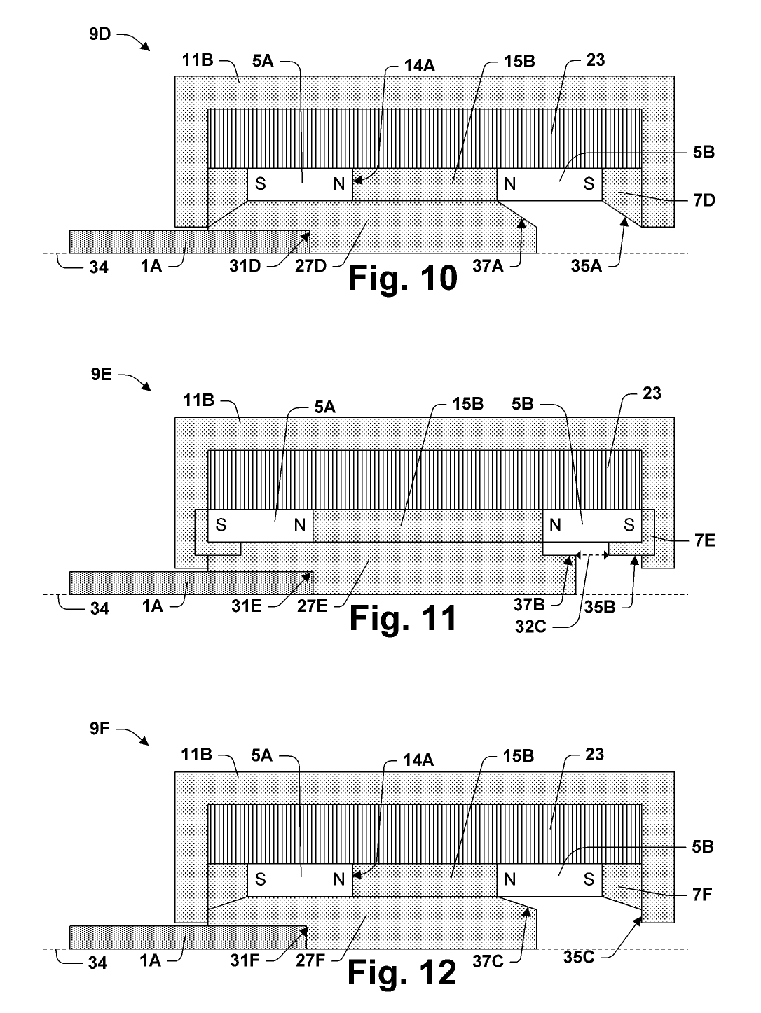

In some of these teachings, low coercivity ferromagnetic portion 27 of armature 31 has edges that are both stepped and tapered. FIG. 12 illustrates an electromechanical actuator 9F providing an example according to these teachings. Stepped and tapered edges 37C on low coercivity ferromagnetic portion 27F of armature 31F mate with stepped and tapered faces 35C provided by pole piece 7F and external frame 11B. Stepped and tapered edges 37C reduce the holding force provided by magnets 5 while increasing the force at the open gap and the speed with which armature 31F can be actuated. The holding force is increased in comparison to actuator 9D in FIG. 10.

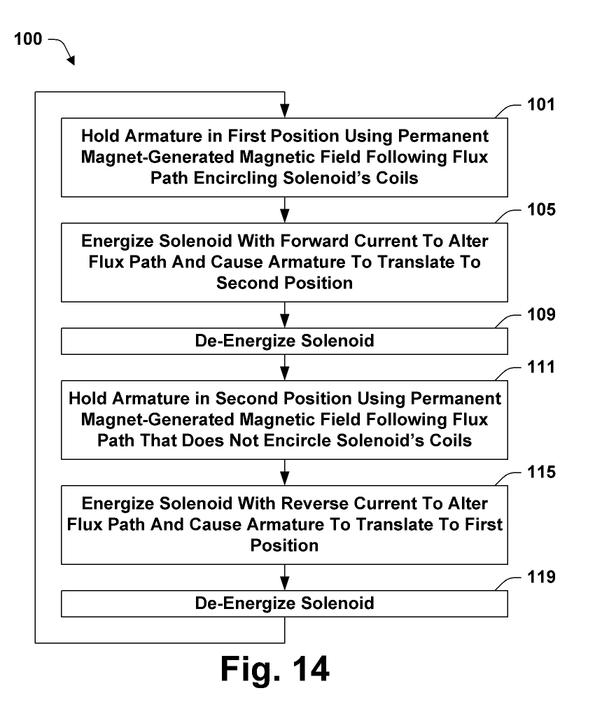

FIG. 14 illustrates a method 100, which is an example according to some aspects of the present teaching. Act 101 is holding an armature 31 in a first position using a permanent magnet 5A-generated magnetic field that follows a flux path 24A that encircles the coils of a solenoid 23. Act 101 may further include holding armature 31 in the first position using a permanent magnet 5B-generated magnetic field that follows a flux path 24C that does not encircle the coils of a solenoid 23.

Act 105 is energizing solenoid 23 with a forward current to alter the flux paths of the magnets 5 and cause armature 31 to migrate toward the second position. Act 105 may occur in response to an instruction to actuate armature 31. The instruction may include generating a control signal that results in a circuit comprising solenoid 23 being connected with a DC voltage source.

Act 109 is optional, but may be desirable to reduce power consumption. Act 109 may be disconnecting solenoid 23 from the DC voltage source and solenoid 23 to power down. Act 109 may occur any time after armature 31 has reached a point 55 from which travel to the second position can be completed without further assistance from solenoid 23.

Act 111 is holding armature 31 in a second position using a permanent magnet 5A-generated magnetic field that follows a flux path 24B that does not encircle the coils of a solenoid 23. Act 111 may further include holding armature 31 in the second position using a permanent magnet 56-generated magnetic field that follows a flux path 24D that encircle the coils of a solenoid 23.

Act 115 is energizing solenoid 23 with a reverse current to alter the flux paths of the magnets 5 holding armature 31 in the second position and cause armature 31 to migrate back toward the first position. Act 115 may also occur in response to an instruction to actuate armature 31 although different instructions may be used for forward and reverse actuations. Act 119 is another optional act that may be disconnecting solenoid 23 from a DC voltage source and allowing solenoid 23's power to dissipate. Acts 101-119 may be repeated many times over the course of operating an actuator 9.

The components and features of the present disclosure have been shown and/or described in terms of certain embodiments and examples. While a particular component or feature, or a broad or narrow formulation of that component or feature, may have been described in relation to only one embodiment or one example, all components and features in either their broad or narrow formulations may be combined with other components or features to the extent such combinations would be recognized as logical by one of ordinary skill in the art.

### INDUSTRIAL APPLICABILITY

The present disclosure provides a simply constructed, compact, and highly efficient electromagnetic actuator.

1. (canceled)

2. A latching electromechanical actuator, comprising:
a coil comprising a plurality of loops around an axis;
an armature a portion of which is of low coercivity ferromagnetic material;
a structure comprising one or more sections of low coercivity ferromagnetic material outside of the loops; and
a permanent magnet positioned between the loops and the armature;
wherein the armature is held on the axis, but is movable along the axis between a first position and a second position;
with the armature in the first position, the actuator forms a first magnetic circuit that passes through the armature and around the loops via the structure outside of the loops
with the armature in the second position, the actuator forms a second magnetic flux circuit that passes through the armature but not around the loops
the permanent magnet is operative to stabilize the armature in the first position through magnetic flux following the first magnetic circuit;
the permanent magnet is operative to stabilize the armature in the second position through magnetic flux following the second magnetic circuit; and
both the first and second positions are stable positions for the armature in the absence of magnetic fields from the coil or any external source.

3. The electromechanical actuator of claim 2, wherein the permanent magnet is held stationary relative to the coil.

4. The electromechanical actuator of claim 3, further comprising a pole piece positioned within the coil adjacent the armature, abutting a pole (14A) of the permanent magnet, and forming part of the second magnetic circuit.

5. (canceled)

6. The electromechanical actuator of claim 3, wherein:
the armature has a stepped edge formed of low coercivity ferromagnetic material;
when the armature is in the first position, the stepped edge of the armature mates with low coercivity ferromagnetic material forming part of the first magnetic circuit; and
the first magnetic circuit includes the stepped edge.

7. The electromechanical actuator of claim 3, wherein the permanent magnet is polarized in a direction parallel to the axis.

8. (canceled)

9. The electromechanical actuator of claim 2, further comprising a spring biasing the armature from the second position toward the first position.

10. The electromechanical actuator of claim 9, further comprising a second spring biasing the armature from the first position toward the second position.

11. (canceled)

12. The electromechanical actuator of claim 3, further comprising:
a second permanent magnet positioned between the and the armature;
wherein with the armature in the second position, the actuator forms a third magnetic circuit that passes through the armature and around the coils via the structure outside of the loops
with the armature in the first position, the actuator forms a fourth magnetic circuit that passes through the armature but not around the loops
the second permanent magnet is operative to stabilize the armature in the first position through magnetic flux following the third magnetic circuit; and
the permanent magnet is operative to stabilize the armature in the second position through magnetic flux following the fourth magnetic circuit.

13. The electromechanical actuator of claim 12, wherein:
when the armature is in the first position, the actuator forms a primary path for magnet flux from the coil having a first air gap; and
when the armature is in the second position, the actuator forms a primary path for magnet flux from the coil having a second air gap at a location distal from the first air gap.

14. The electromechanical actuator of claim 12, wherein the polarities of the permanent magnets are confronting.

15. The electromechanical actuator of claim 14, wherein:
the first position is a first limit of travel for the armature;
the second position is a second limit of travel for the armature;
when the armature is in the first position and in the absence of magnetic fields from the coil or any external source, the armature is held in the first position by a holding force provided in part by the first permanent magnet and in part by the second permanent magnet; and
when the armature is in the second position and in the absence of magnetic fields from the coil or any external source, the armature is held in the second position by a holding force provided in part by the first permanent magnet and in part by the second permanent magnet.

16. The electromechanical actuator of claim 14, further comprising a pole piece of low coercivity ferromagnetic material positioned within the coil and between the two permanent magnets.

17. The electromechanical actuator of claim 14, wherein:
the coil has a first end and a second end;
the first permanent magnet is proximate the first end; and
the second permanent magnet is proximate the second end.

18. The electromechanical actuator of claim 17, wherein the first and second permanent magnets are entirely within the coil.

19. A method of operating an electromechanical actuator having a coil of wire loops and an armature, comprising:
holding the armature in a first position using a permanent magnet that generates a magnetic field following a first flux path that encircles the coil's loops;
connecting the coil to a DC voltage source having a first polarity to generate a magnetic field that redirects the magnetic flux from the permanent magnet and causes the armature to be displaced from the first position to a second position;
disconnecting the coil from the DC voltage source;
holding the armature in the second position using the permanent magnet, wherein the first permanent magnet generates a magnetic field that follows a second flux path, which does not encircle the coil's loops; and
connecting the coil to a DC voltage source having a second polarity, which is a reverse of the first polarity, to generate a magnetic field that redirects the magnetic flux from the permanent magnet and causes the armature to be displaced from the second position to the first position.

20. The method of claim 19, wherein:
the holding of the armature in the first position using the permanent magnet further comprises holding the armature in the first position using a second permanent magnet that generates a magnetic field following a third flux path that does not encircle the coil's loops; and
the holding of the armature in the second position using the first permanent magnet further comprises holding the armature in the second position using a second permanent magnet that generates a magnetic field following a fourth flux path that encircles the coil's loops.

21. The electromechanical actuator of claim 12, wherein the second permanent magnet is held stationary with respect to the coil.

22. The electromechanical actuator of claim 3, wherein:
the first position is a first limit of travel for the armature; and
the second position is a second limit of travel for the armature.

23. A latching electromechanical actuator, comprising:
a coil;
an armature a portion of which is of low coercivity ferromagnetic material; and
a permanent magnet inside the coil and held stationary relative to the coil;
wherein the armature is movable along an axis between a first position and a second position;
the permanent magnet is operative to stabilize the armature in the first position;
the permanent magnet is operative to stabilize the armature in the second position;
both the first and second positions are stable positions for the armature in the absence of magnetic fields from the coil or any external source
the first position is a first limit of travel for the armature; and
the second position is a second limit of travel for the armature.

24. A latching electromechanical actuator according to claim 23, further comprising:
a second permanent magnet inside the coil and held stationary relative to the coil; and
a pole piece inside the coil, held stationary relative to the coil, positioned between the first permanent magnet and the second permanent magnet, abutting a pole of the first permanent magnet, and abutting a pole of the second permanent magnet;
wherein the poles of the permanent magnets that abut the pole piece have like polarity.
